(19) United States
(12) Patent Application Publication
(10) Pub. No.: US 2003/0036992 A1
(43) Pub. Date: Feb. 20, 2003

(54) Computer systems, nodes and methods for multi-party agreement negotiation

(76) Inventors: Christopher William Preist, Bristol (GB); Claudio Bartolini, Bristol (GB); Andrew Robert Byde, Bristol (GB)

Correspondence Address: HEWLETT-PACKARD COMPANY, Intellectual Property Administration, P.O. Box 272400, Fort Collins, CO, 80527-2400, US

(21) Appl. No.: 10/215,465

(22) Filed: Aug. 9, 2002

(30) Foreign Application Priority Data
Aug. 11, 2001 (GB) 0119642.7

(51) Int. Cl. G06F 17/60

(52) U.S. Cl. 705/37

(57) ABSTRACT

A computer system allows negotiation of a multi-party agreement between a plurality of entities. The computer system comprising a plurality of computer nodes; a computer node being arranged to define negotiation rules between the entities; wherein the computer node is operable for a plurality of entities to bid for one or more of a plurality of roles in the negotiation, in which one entity can constrain the role or roles of another entity for an acceptable negotiation.

### INCORPORATION BY REFERENCE

This application incorporates by reference the specification of U.S. patent application Ser. No. 10/035,700, filed on Oct. 29, 2001, entitled “Method and Apparatus for Negotiation”.

### FIELD OF INVENTION

The present invention relates to computer systems for allowing negotiation of multi-party agreements, and to corresponding computer nodes and communication methods.

### DESCRIPTION OF PRIOR ART

Computer systems which allow a number of parties to negotiate are known: examples are described in WO 01/75756, WO 01/29663 and WO 00/65516. However, these arrangements are typically not sufficiently flexible in the arrangements that they allow between multiple parties involved in the negotiation process.

### SUMMARY OF INVENTION

According to the present invention in a first aspect, there is provided a computer system for allowing negotiation of a multi-party agreement between a plurality of entities, the computer system comprising a plurality of computer nodes; a computer node being arranged to define negotiation rules between the entities; wherein the computer node is operable for a plurality of entities to bid for one or more of a plurality of roles in the negotiation, in which one entity can constrain the role or roles of another entity for an acceptable negotiation.

Suitably, the constraint is of the role or roles to be undertaken by another entity.

Suitably, the constraint is that another party shall fulfil a specified role or roles.

Suitably, the constraint is that another party shall not fulfil a specified role or roles.

Suitably, the constraint is a parameter of the negotiation.

Suitably, the parameter is a parameter value.

According to the present invention in a second aspect, there is provided a computer system for allowing negotiation of a multi-party agreement between a plurality of entities each entity having a role or roles in the negotiation, the computer system comprising a plurality of computer nodes; a computer node being arranged to define negotiation rules between the entities; wherein an at least partly-instantiated agreement is provided to a plurality of entities and the at least partly-instantiated agreement is selectively revealed to the entities according to their role or roles.

Suitably, a part of the at least partly-instantiated agreement is revealed to all entities.

Suitably, a part of the at least partly-instantiated agreement is revealed to a plurality of entities but not to all entities, according to their role or roles.

Suitably, a plurality of nodes are arranged to define the negotiation between the entities with a set of negotiation activities; wherein each of the plurality of nodes are operable to implement a plurality of negotiation rule sets.

Suitably, at least one of the entities is a software negotiation agent.

Suitably, the computer node incorporates the software negotiation agent.

Suitably, at least one of the entities is a user.

Suitably, at least one of the entities is a negotiation host and at least another of the entities is a negotiation participant.

Suitably, at least one of the rule sets constrains the negotiation activities to an auction and at least another rule set constrains the negotiation activities to a one on one negotiation.

Suitably, the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

Suitably, the negotiation activities further includes a protocol enforcer for rejecting invalid proposals.

Suitably, the negotiation activities further includes an information editor for providing to the participant summarised proposal information through the negotiation locale.

Suitably, the negotiation activities further includes an agreement maker for determining criteria for establishing an agreement based on the received proposals.

According to the present invention in a third aspect, there is provided a computer node for coupling to a computer system to allow negotiation of a multi-party agreement between a plurality of entities, the computer node comprising a processor, the processor being configured to define negotiation rules between the entities; wherein the computer node is operable for a plurality of entities to bid for one or more of a plurality of roles in the negotiation, in which one entity can constrain the role or roles of another entity for an acceptable negotiation.

Suitably, the constraint is of the role or roles to be undertaken by another entity.

Suitably, the constraint is that another party shall fulfil a specified role or roles.

Suitably, the constraint is that another party shall not fulfil a specified role or roles.

Suitably, the constraint is a parameter of the negotiation.

Suitably, the parameter is a parameter value.

According to the present invention in a fourth aspect, there is provided a computer node for allowing negotiation of a multi-party agreement between a plurality of entities each entity having a role or roles in the negotiation, the computer node comprising a processor; the computer node being arranged to define negotiation rules between the entities; wherein an at least partly-instantiated agreement is provided to a plurality of entities and the at least partly-instantiated agreement is selectively revealed to the entities according to their role or roles.

Suitably, a part of the at least partly-instantiated agreement is revealed to all entities.

Suitably, a part of the at least partly-instantiated agreement is revealed to a plurality of entities but not to all entities, according to their role or roles.

Suitably, at least one of the entities is a software negotiation agent.

Suitably, the computer node incorporates the software negotiation agent.

Suitably, at least one of the entities is a user.

Suitably, at least one of the entities is a negotiation host and at least another of the entities is a negotiation participant.

Suitably, at least one of the rule sets constrains the negotiation activities to an auction and at least another rule set constrains the negotiation activities to a one on one negotiation.

According to the present invention in a fifth aspect, there is provided a method for negotiation communication for a multi-party agreement between a plurality of entities via a distributed electronic network having a plurality of nodes, the method comprising in a node defining negotiation rules between the entities; and allowing entities to bid for one or more of a plurality of roles; the negotiation, in which one entity can constrain the role or roles of another entity for an acceptable negotiation.

According to the present invention in a sixth aspect, there is provided for a multi-party agreement a method for negotiation communication between a plurality of entities via a distributed electronic network having a plurality of nodes, the method comprising in a node defining negotiation rules between the entities; providing to a plurality of entities an at least partly-instantiated agreement, and selectively revealing the partly-instantiated agreement to the entities according to their role or roles.

### BRIEF DESCRIPTION OF DRAWINGS

The present invention will now be described, by way of example only, with reference to the drawings that follow; in which:

FIG. 1 is a schematic illustration of an apparatus according to an embodiment of the present invention.

FIG. 2 is a schematic illustration of the functional units of a negotiation host for use in embodiments of the present invention.

FIG. 3 is a diagrammatic illustration of an overview of a method according to an embodiment of the present invention.

FIG. 4 is a diagrammatic illustration of part of a negotiation process according to an embodiment of the present invention.

FIG. 5 is a functional block diagrammatic illustration of a proposal submission sub-step.

FIG. 6 is a diagrammatic illustration of the relationship between parties and entities in a negotiation method according to an embodiment of the present invention.

FIG. 7 is a diagrammatic illustration of a viewable partly instantiated agreement from part of the method of FIG. 6.

### SPECIFIC DESCRIPTION OF PREFERRED EMBODIMENTS

Negotiation is the process by which two or more entities interact to reach an agreement such as a contract for the supply of goods or services, though the present invention is not limited to negotiations associated with contractual agreements. The present invention is concerned with negotiations for multi-party agreements in which the final agreement has more than two parties.

There will now be described a general protocol for negotiation between two or more parties. This general protocol is further described in U.S. patent application Ser. No. 10/035,700, which is incorporated by reference herein. The protocol is parameterised by a set of rules. By choosing a specific set of rules to enforce a negotiation a negotiation host can create a specific market mechanism.

The negotiation protocol, described below, can be supported using messaging middleware, for example, the Java™ Message Service (JMS). Examples of industrial systems implementing JMS are Progress Software SonicMQ and IBM MQSeries. Open source JMS systems such as JbossMQ from Jboss.org are also available.

Alternatively, the protocol can be layered on top of a message transport service.

To enable participants to negotiate with one another an agreement template is defined, usually but not necessarily by the negotiation host. The negotiation template specifies the different parameters of the negotiation such as, for an agreement for the supply of goods, product type, price, supply, date etc. Some parameters may be constrained within the template, for instance product type will nearly always be tightly constrained, whereas others may be specified as a range or limit (eg supply date), or left completely open (eg price).

As part of the admission process of participants to the negotiation, they are requested to accept a agreement template. The admission step might be formalized by the specification of admission policies. The admission policies can specify what credentials (if any) are requested from participants for them to be admitted to the negotiation.

Depending on what parameters a party is willing to negotiate on, it will adopt more or less constrained agreement templates. For example, a party that is willing to negotiate nothing (such as a catalogue) will only advertise a fully instantiated agreement template, with a fixed price. A party willing to negotiate features of a product, such as colour, as well as price and delivery date, will leave these parameters unconstrained.

The process of negotiation is the move from an agreement template to an agreement, which the agreeing parties find acceptable. A single negotiation may involve many parties, resulting in several agreements between different parties and some parties who do not reach agreement. For example, a stock exchange can be viewed as a negotiation where many buyers and many sellers meet to negotiate the price of a given stock. Many agreements are formed between buyers and sellers, and some buyers and sellers fail to trade.

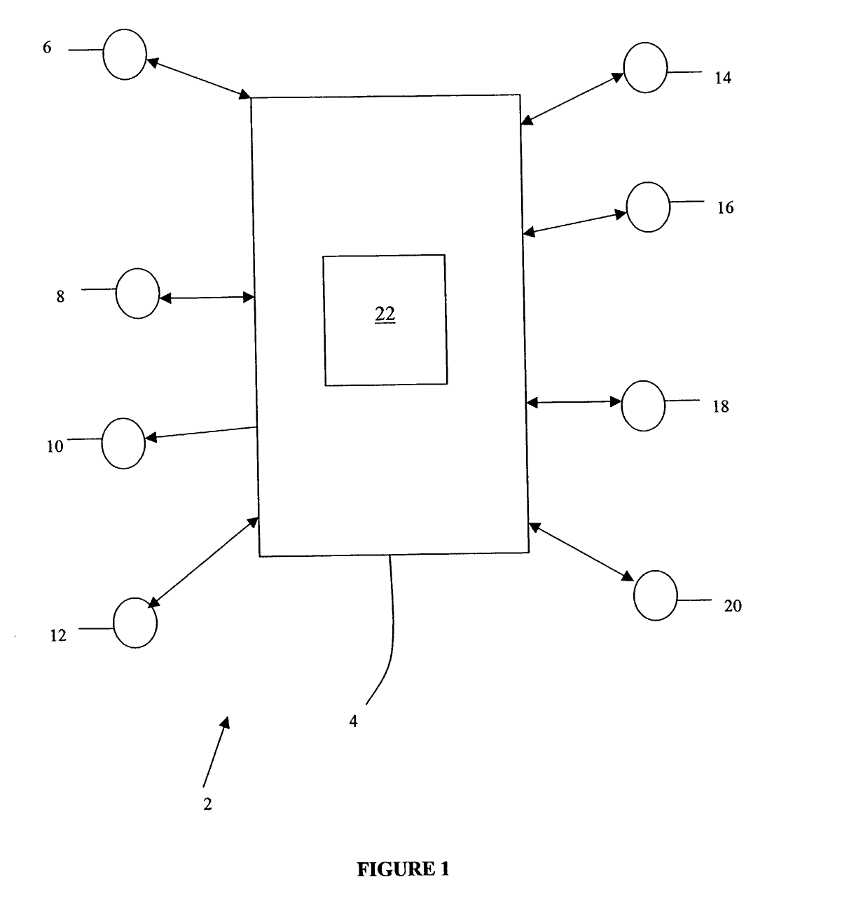

In the process of reaching agreements, the negotiation participants exchange proposals representing the deals that are currently acceptable to them. Each proposal will contain constraints over some of the parameters expressed in the agreement template.Referring to FIG. 1 of the accompanying drawings there is shown a computer system 2 comprising a plurality of computer nodes 4-20. In this embodiment computer nodes 6-20 communicate with each other via computer node 4, which is a software negotiation agent, using the internet, though other communication methods and routes can be utilised. Computer node 4 comprises a processor 22 programmed and configured to operate according to the present invention.

Each computer node 4-20 represents an entity that is a possible party to a multi-party agreement. One or more computer nodes 4-20 may represent a user, though the present invention is also suited to automatic, computer controlled negotiations. In this embodiment, computer node 4 acts as a negotiation host. The negotiation host is typically the role responsible for enforcing the protocol and enforcement of rules governing negotiation, for example participation, execution, resolution and termination of a negotiation. The negotiation host 4 may have some, or all, of the following sub-roles/activities:

Gatekeeper role for enforcing the policies governing admission to a negotiation.

Infrastructure provider role for providing the underlying communications infrastructure of the

negotiation locale. The infrastructure provider forwards proposals and information updates, according to the visibility rules defined by the negotiation host.

Proposal validator role for ensuring that a proposal is well formed with respect to the agreement template.

Protocol enforcer role for ensuring that participants' proposals are posted and withdrawn according to the negotiation rules.

Agreement maker role for agreement formation.

Information updater role for notifying participants of the current state of the negotiation, according to the display rules.

As described below, negotiation may take place between two entities where one of the entities is represented by the negotiation host 4, as in one to one negotiation; or the negotiation host 4 can act as a controlling third party, as in an English auction. Alternatively, as will be described further below, a number of the computer nodes 4-20 can participate in a multi-party negotiation to form a multi-party agreement.

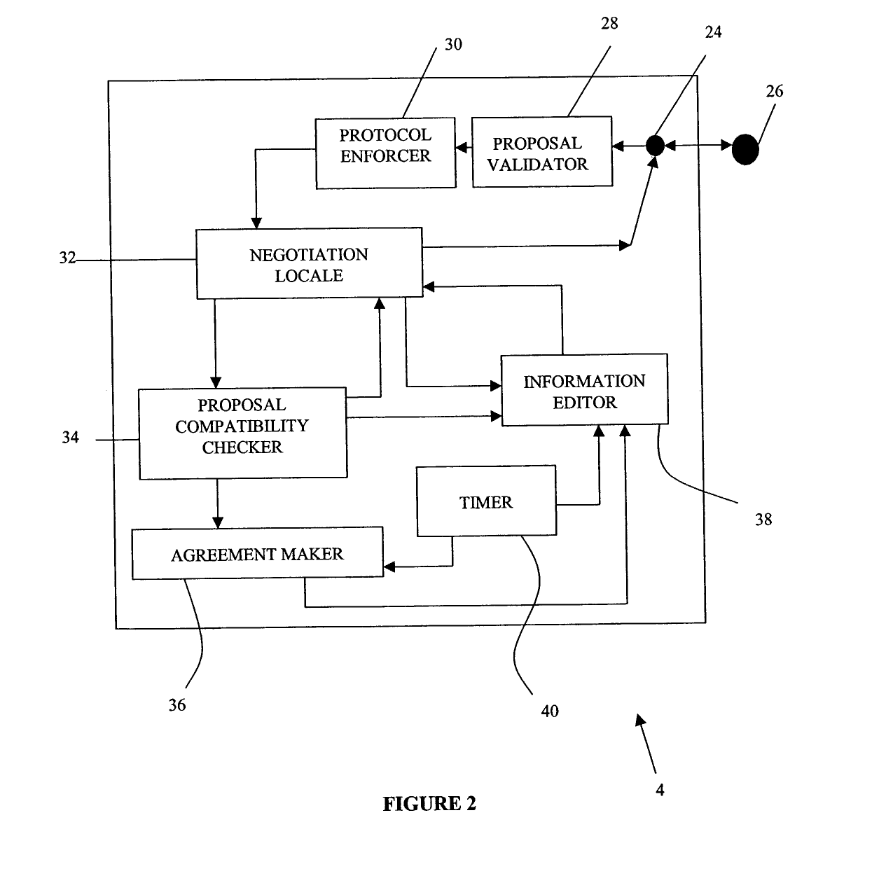

Referring to FIG. 2 of the accompanying drawings, the functional blocks of the computer node 4 are shown in more detail.

Computer node 4 comprises a data input/output port 24 for receiving data from data source 26, typically communications from the other computer nodes 6-20. Incoming data to port 24 is provided to proposal validator 28 for validating proposals against an agreement template and to a protocol enforcer 30 for rejecting invalid proposals. A negotiation locale 32 receives validated proposals and communicates part or all of them to the relevant party or parties via port 24. Negotiation locale 32 communicates with proposal compatibility checker 34, which compares proposals posted to the negotiation locale 32 to determine whether a compatible set of proposals have been made. Agreement maker 36 receives compatible proposals from proposal compatibility checker 34 and optimises an agreement. An information editor 38 summarises information regarding the negotiation process is from negotiation locale 32, proposal compatibility checker 34, agreement maker 36 and a timer 40 for feeding it back to the negotiation locate 32. Timer 40 provides general and elapsed time information for the process to agreement maker 36 and information editor 38.

To enable participants to negotiate with one another an agreement template is defined, usually but not necessarily by the negotiation host. The negotiation template specifies the different parameters of the negotiation such as, for an agreement for the supply of goods, product type, price, supply, date etc. Some parameters may be constrained within the template, for instance product type will nearly always be tightly constrained, whereas others may be specified as a range or limit (eg supply date), or left completely open (eg price).

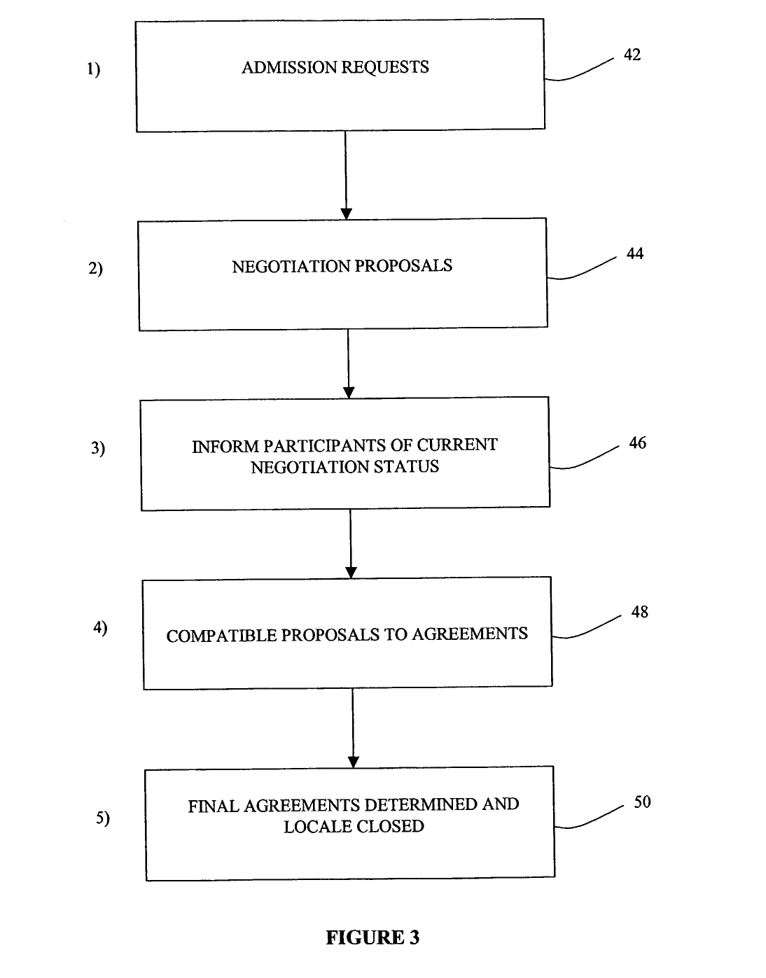

Referring to FIG. 3 of the accompanying drawings, the negotiation protocol consists of five stages:

Stage 1 Potential participants make requests of the negotiation host for admission to the negotiation (42).

Stage 2 Negotiation takes place by proposals being made by the participants (44).

Stage 3 The negotiation host informs the participants of the current status of the negotiation (46).

Stage 4 The negotiation host identifies compatible proposals and converts them to agreements (48).

Stage 5 Any final agreements are determined and the negotiation host closes the negotiation locale (50).

The process of negotiation will now be described more fully. Negotiation takes place by parties communicating through the negotiation locale. The negotiation locale is an abstraction over the messaging system that is used by negotiation participants to address each other where the negotiation locale, typically, has an agreement template associated with it. The agreement template defines the subject of negotiation within the negotiation locale.

After admission to negotiation, a participant is given access to the negotiation locale. This locale may already exist, or may be created specifically for this new negotiation. Along with the access, the participant is given a mailbox where messages encoding negotiation proposals will be delivered. Each participant can send proposals by broadcasting them to the negotiation locale. Reliable delivery and security will be enforced by the underlying messaging infrastructure. Singling out a counterpart can be achieved by limiting the visibility of the broadcast message, in case the market mechanism rules allow it. That allows one-to-one negotiation to be modelled as a particular case of many-to-many negotiation.

The negotiation participant participates in a negotiation by posting proposals according to the rules provided by the negotiation host.

These proposals are sent to the negotiation locale, and can then be viewed by other negotiation participants. However, before a proposal is distributed by the locale, it must be valid.

Each time a participant submits a proposal by posting it to the negotiation locale, the negotiation host, in the role of proposal validator, validates the proposal against the agreement template. It checks that the proposal is a constrained form of the agreement template, and is syntactically well formed. That is the constraints over the parameters in the proposal must be tighter that the corresponding ones in the agreement template. The constraints represent acceptable values to the proposing participant. (Often, these constraints will be a single acceptable value of a parameter).

If the proposal is not valid, then it is rejected. If the proposal passes this first stage of validation, then the negotiation host (playing here the role of protocol enforcer) validates the proposal against the negotiation rules. The negotiation rules define the way in which the negotiation should take place, and may include restrictions on when a proposal can be made (e.g. participants must take turns to submit) and semantic requirements on valid proposals (e.g. requirements that a proposal must improve on previous ones).

If the proposal passes this second stage of validation, then the current set of proposals and associated data structures are updated accordingly and participants are notified. Who is notified, and the structure of the notification, is defined by visibility rules and information filtering rules.

The negotiation host (this time in the agreement maker role) then looks at the current set of proposals to determine whether agreements can be made. Agreements can potentially occur whenever two or more negotiating parties make compatible proposals. In this case, agreement formation rules determine exactly which proposals are matched with each other, and the final instantiated agreement that will be used. Agreement rules may state, for example, that the highest priced offer to buy should be matched with the lowest priced offer to sell, and that the final agreement will take place at the average price. Often, ‘tie breaking’ agreement rules will be defined that will be used if the main agreement rules can be applied in several ways. For example, earlier posted offers may take priority over later ones.

The participants now exchange proposals until termination is reached. Agreement formation can occur at any time (for example when two proposals are matched in a continuous double auction). Agreement formation may trigger termination (e.g. one-to-one negotiation) or may not (e.g. continuous double auction).

One example of a set of negotiation activities that can be utilised to form a general protocol is the following:

Posting

This includes negotiation rules that determine the circumstances in which a participant may post a proposal.

Visibility

This includes negotiation rules that specifying who, among the participants, has visibility over a submitted proposal.

Display

This includes negotiation rules that specify if and how an information updater notifies the participants that a proposal has been submitted or an agreement has been made —either by transmitting the proposal unchanged or by transmitting a summary of the situation.

Improvement

This includes negotiation rules that specify what new proposals may be posted for a given set of existing proposals,.

Withdrawal

This includes negotiation rules that specify if and when proposals can be withdrawn from negotiation, and policies over the expiration time of proposals.

Termination

This includes negotiation rules that specify when no more proposals may be posted (e.g. a given time, period of quiescence, etc.).

Agreement Formation

This includes negotiation rules that are responsible for determining, given a set of proposals at least one pair of which intersect, which agreements should be formed.

Tie-Breaking

A specific set of agreement formation rules applied after all others.

An implementation described below illustrates the use of the general protocol to define, using the above set of activities with a number of associated negotiation rule sets, a number of different market mechanisms. The market mechanisms illustrated are: a simple shop front, an English auction and a continuous double auction. However, other negotiation rule sets can be used for other market mechanisms, for example dutch auction, sealed bid auction, vickrey auction, reverse auction and open-cry auction. Alternatively, different set of activities can be used with their own set of negotiation rule sets.

For a simple shop front negotiation the actors (i.e. entities) involved are the shopkeeper and one or more buyers. A buyer plays the participant role, whereas the shopkeeper plays both the participant and the negotiation host roles at the same time. The shop front is modelled by the negotiation locale abstraction.

Before negotiation begins, the shopkeeper decides the admission policy, negotiation template, negotiation and agreement formation rules in accordance with standard set of activities. For example:

Admission Policy

This will usually be the null policy: anyone is admitted.

Negotiation Template

The shopkeeper decides on templates of goods it is willing to sell. These will be fully defined, specifying all details exactly, including price. To be valid with respect to the negotiation template, a buyer's proposal must therefore be an exact copy of the seller's proposal (except it is ‘buy’, rather than ‘sell’).

Negotiation Rules

The shopkeeper adopts ‘shop front take it or leave it’negotiation rules. These state that:

Posting rule—A buyer may post a proposal at any time, irrespective of posted proposals by other buyers. A seller may post or withdraw proposals at any time.

Termination rule—Termination occurs when there are no seller proposals posted in the shop front

Agreement Formation Rules

The shopkeeper adopts shop front agreement formation rule:

Agreement formation rule—Agreements are formed whenever a buyer posts a proposal identical to the seller's proposal.

After the rules have been specified, negotiation can begin. The shopkeeper submits proposals for all goods it sells. If it expects high demand, it can place several identical proposals on the table for the same good. If all proposals for a given good are accepted, and the shopkeeper still has more in stock, it resubmits identical proposals. A buyer submits a proposal, an identical copy of the shopkeeper's proposal, when it wishes to purchase a given good. Agreement formation occurs as the shopkeeper—in the negotiation host role—identifies valid buyer proposals and sends agreements to the buyers.

For an English auction the actors (i.e. entities) involved are a seller and various buyers in the role of participants. The auctioneer that auctions the item on behalf of the seller plays the negotiation host role. The auction room is modelled as a negotiation locale. An example of admission policy, negotiation template and negotiation and agreement formation rules are:

Admission Policy

Auctioneer and seller decide the policy. This could be the null policy—anyone is admitted—or they could restrict admission to a number of invitees on presentation of an invitation certificate (participant's credential).

Negotiation template

The seller decides on the template of the good it is selling. This will be fully defined, specifying all details exactly, except for the price attribute, which will be constrained to be greater than an initial reservation price. To be valid with respect to the negotiation template, a buyer's proposal must therefore be an exact copy of the seller's proposal except for having a price that is higher than what is specified in the negotiation template as initial reservation price.

Negotiation Rules

The auctioneer adopts English auction negotiation rules. These state that:

Posting rule—A buyer may post a proposal at any time.

Improvement rule—The price field of the buyer's proposal must be a certain increment above the value of all previously posted buyer proposals

Withdrawal rule—It is not possible to withdraw a proposal that represent the currently highest bid.

Visibility rule—The proposals that buyers submit are visible to all the participants.

Termination rule—Termination occurs at a fixed time or after a period of inactivity

Agreement Formation Rules

The auctioneer adopts the English auction agreement formation rule, that states:

Agreement formation rule—After termination, an agreement between the highest bidding buyer and the seller is formed for the item fully specified in the template to be sold to the buyer at the price specified in the highest bid.

When the negotiation is open, buyers submit proposals with the price instantiated to its bid value. At the deadline, the auctioneer identifies the highest bidding buyer, and forms agreement between the highest bidding buyer and the seller. It finally notifies both parties.

For a multiple item continuous double auction, for example the stock exchange, the actors (i.e. entities) are traders as participants and the market maker as the negotiation host. The negotiation locale is the exchange floor. An example of admission policy, negotiation template and rules are:

Admission Policy

Either the null policy—anyone is admitted—or admission on presentation of credentials such as qualified trader.

Negotiation Template

The market maker decides on the template of goods that are traded in the exchange. This will be fully defined, specifying all details exactly, except for the price attribute and quantity attribute, which will be open. To be valid with respect to the negotiation template, proposals must therefore be a copy of the proposal template, with price and quantity instantiated to specific values.

Negotiation Rules

The market maker adopts continuous double auction negotiation rules. These state that:

Posting rule—Buyers and sellers may post proposals at any time.

Improvement rule—The price field of a buyer's proposal must be above the value of all currently posted buyer proposals. The price field of a seller's proposal must be below the value of all currently posted seller proposals.

Withdrawal rule—Any proposal can be withdrawn at any moment, before an agreement is formed that involves it.

Visibility rule—Proposals are only visible to the market maker, in order to protect the participants from receiving too much information.

Display rule—The market maker regularly updates the order books, containing information on proposals to buy and to sell, ordered by price.

Termination rule—Termination occurs only when the auction ceases to be used.

Agreement formation rules

The market maker adopts continuous double auction agreement formation rules. These state that:

Agreement formation rule—Agreement is formed between all overlapping buyers and sellers. The price is the midpoint of the overlap. Highest buyers and lowest sellers are satisfied first. When traders have different quantities, this may result in a single party having trades with several others (multiple agreements).

Tie breaking rule—In case of ties, earlier proposals have priority.

During negotiation, the traders continuously exchange proposals. Agreement formation occurs whenever there is an overlap between buyers and sellers proposals, according to the rules above. Participants are notified of any agreements made.

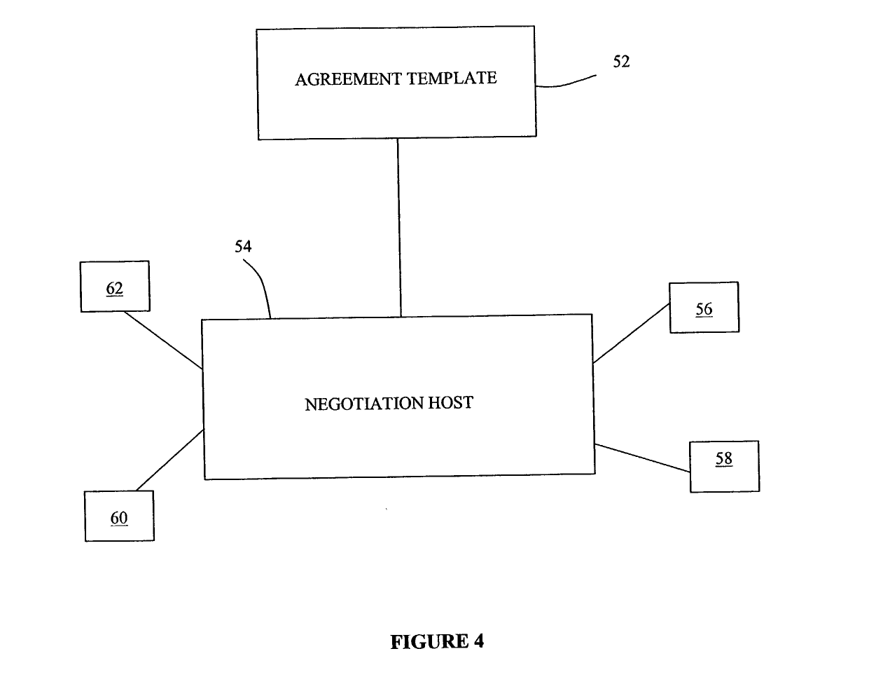

Embodiments of the present invention using this general protocol will now be described with reference to FIGS. 4 to 7. It will be appreciated that other embodiments not in full accordance with this general protocol could readily be devised by the skilled person.

FIG. 4 of the accompanying drawings shows an overview of a method of an embodiment of the present invention for a specific example of four potential negotiation participant entities seeking to reach agreement for the division into three parts of a resource. The negotiation is to determine the percentage of the resource allocated to each entity.

First an agreement template 52 is established by a negotiation host 54. Potential negotiation participants 56, 58, 60 and 62 communicate with the negotiation host to obtain the agreement template 52. The agreement template 52 defines the roles that will be involved in the multi-party agreement and the interactions possible between those roles, for instance whether one party can take more than one role.

To be admitted to the negotiation, potential participants may be required to provide evidence of their credentials. They will then specify which role (or roles) they are interested in the negotiation. The negotiation templates determine which role (or roles) a given party can bid for given the accepted credentials. During negotiations, validation rules allow participants to submit proposals to undertake only the roles for which they have been admitted.

The agreement template 52, in this example includes the following agreement template rules:

1. For admission all participants must prove their identity and a predetermined credit limit.

2. No participant may take more than one role.

3. Proposals may constrain what percentage of the resource other parties may be allocated.

4. No party may submit a proposal for more than 65% of the resource.

5. No party may submit a proposal for less than 5% of the resource.

6. All proposals must provide for 100% of the resource to be allocated.

Assuming entities 56-62 are all admitted to the negotiation (step 42 in FIG. 3) they become negotiation participants (but not parties as no agreement has yet been reached).

Next, in step 44 of FIG. 3, negotiation proposals are made. Admitted participants submit proposals specifying the role they want to play, selected from the role (or roles) for which they have been admitted. The proposals may also constrain who should (or should not) play the other roles. Proposals specify constraints over some of the parameters defined in the agreement template 52. It will generally be a requirement that a valid proposal must be more constrained than the corresponding terms in the agreement template 52. The constraints represent acceptable values of the parameters to the proposing participant.

A proposal may also constrain what parameter values of other parties are acceptable to the proposing party.

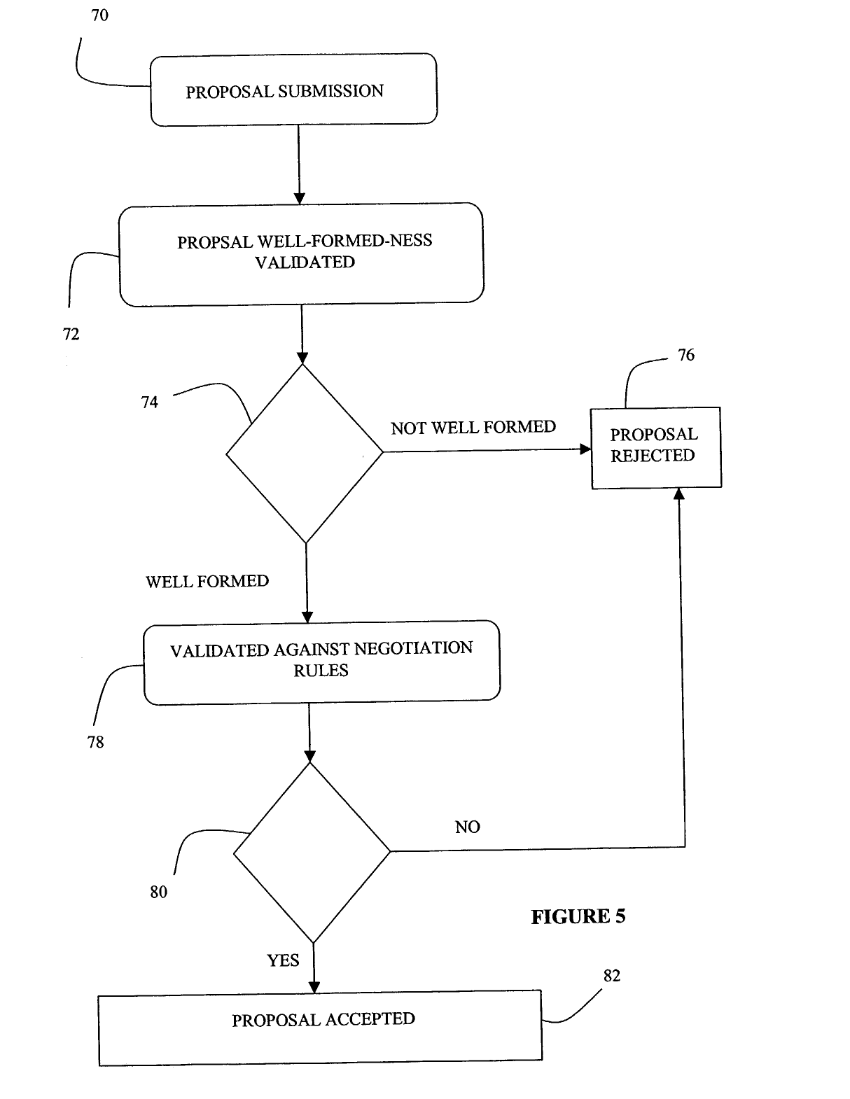

Referring to FIG. 5 of the accompanying drawings, a proposal submission activity diagram shows the sub-steps involved therein. A proposal is submitted at step 70 and the well-formed-ness of the proposal is determined by proposal validator 28 at step 72. This determines whether the proposal can be considered against the agreement template 52. For instance it will consider whether the proposal relates to the correct agreement, whether it is within any applicable time limits, etc.

At step 74, if the proposal is not well formed, it is rejected (step 76). If the proposal is well formed it is validated against the negotiation template 52 by protocol enforcer 30 at step 78. This determines whether the proposal falls within the terms of the agreement template 52. If at step 80 the proposal does comply with the agreement template 52 at step 82, the proposal is accepted for consideration. If not, the proposal is rejected (step 76).

To take the above example of the resource, if the participants submit the following proposals (for ease of reference and understanding parties 56-62 are allocated respective letters A-D):

| PARTICIPANT | PROPOSAL |
|---|---|
| 56 (A) | A > 35%, B < 40%, C: any, D: not to |
| | participate |
| 58 (B) | A: any, B > 30%, C: > 25%, D: < 30% |
| 60 (C) | A < 50%, B: any, C > 25%, D > 15% |
| 62 (D) | A: < 10%, B: < 20%, C > 15%, D > 80% |

It is noted that in this negotiation, each party not only bids for a percentage of the resource for itself, it also sets limits or constraints on the percentage available to another party or other parties in the negotiation. Thus, in the negotiation, a participating entity can constrain the possible agreement outcomes in relation to another participating entity and specify that the one entity will only reach an agreement if the agreement in relation to another party falls within predetermined terms.

It will be appreciated that if entity A bids for more than 30% of a resource, this itself constrains the other entities to no more than 70% of the resource between them (ie the total cannot exceed 100%). The constraints referred to in the preceding paragraph are in addition to any such implicit constraints.

All proposals are well formed and are validated at steps 72 and 74 of FIG. 5. However at steps 78 and 80 of FIG. 5 the proposal from party 62 (D) is rejected (step 76) because it does not comply with rule number 4 of the agreement template 52 that no party may submit a proposal for more than 65% of the resource. This is communicated to party 62 (D), which communication may include an explanation of why the proposal is rejected and an invitation to re-submit a valid proposal (optionally with a time limit for doing so).

The other proposals are accepted (step 82 of FIG. 5).

There are now three accepted proposals from participants 56 (A), 58 (B) and 60 (C).

At step 48 (FIG. 3), proposal compatibility checker 34 determines whether the proposals can be reconciled to form an agreement within the terms of the agreement template 52.

In this case, there are compatible proposals within the scope of the agreement template 52, as follows:

35%<A<45%

30%<B<40%

25%<C<35%

Exactly which possible agreement within these ranges is selected depends on the agreement formation rules. These may form part of the original agreement template 52 and optionally may be revealed to the entities that are potential participants. For instance, it may be specified that the earliest proposal is dominant (ie receives the maximum possible percentage), or that any extra percentage beyond the minimum is divided equally, which in this case would result in the following agreement:

A=39%

B=33%

C=28%

An agreement is then determined by agreement maker 36 and the negotiation locale 32 is closed (step 48 in FIG. 3).

A facility may, subject to the terms of admission to the negotiation, be provided for participants or potential participants to withdraw a proposal.

A constraint may be of the role or roles another party shall or shall not fulfil, or a parameter in a negotiation such as how much of a resource may be bide for, the timescale of a service or delivery, the value of an item etc.

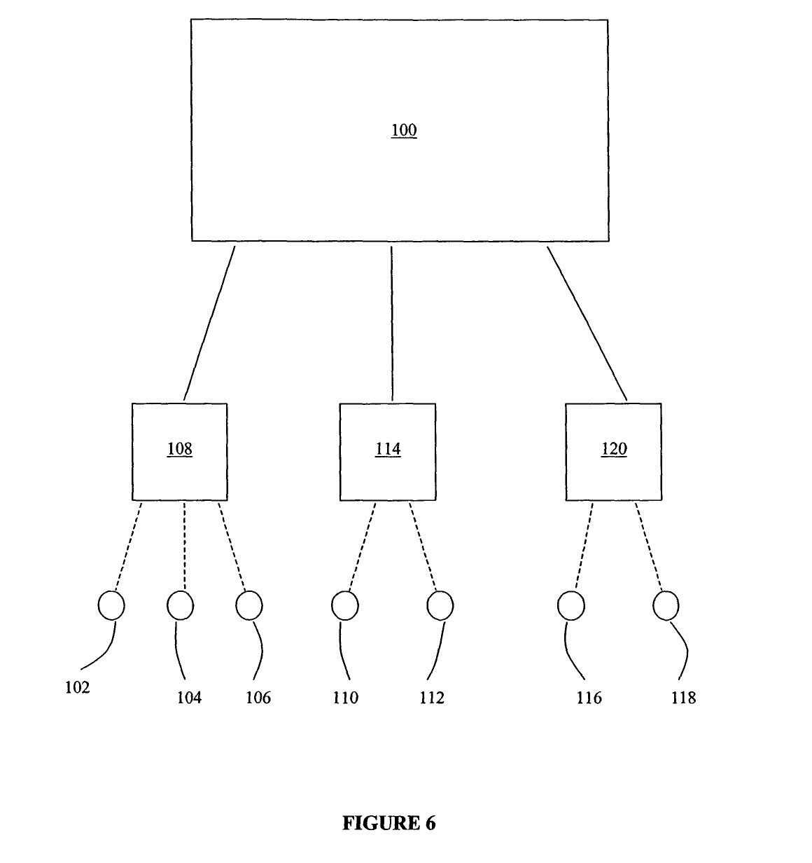

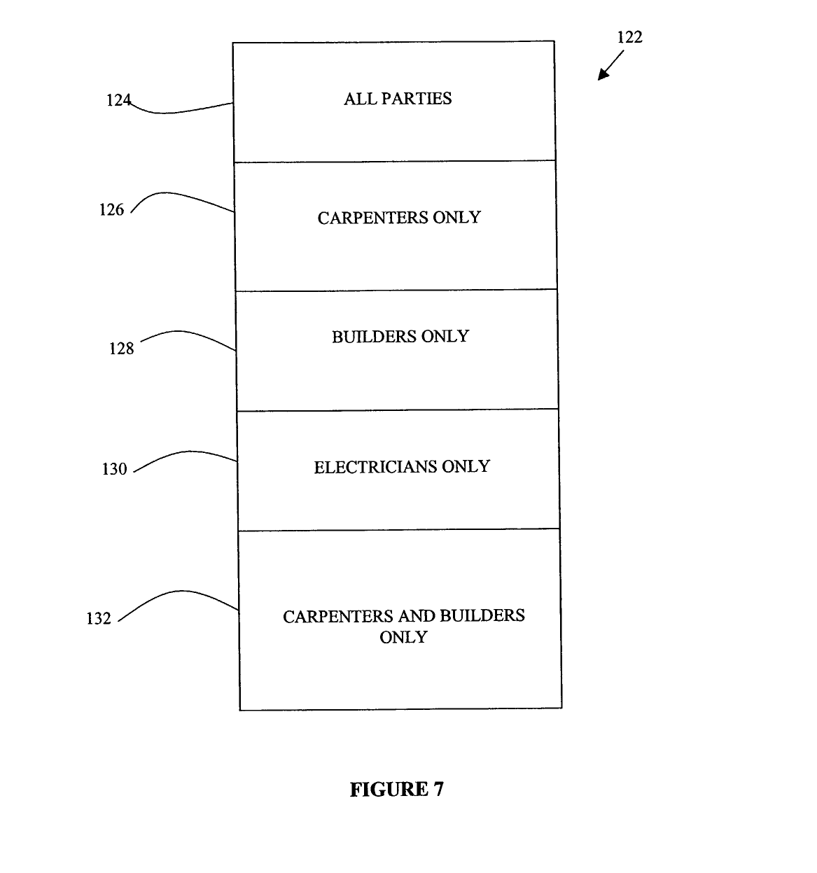

Referring to FIGS. 6 and 7 of the accompanying drawings, there is shown a further embodiment of the present invention.

In the further embodiment, a multi-party agreement is desired between a building contractor 100 and one of the entities 102, 104, 106 to fulfil the role of a carpenter 108, one of the entities 110, 112 to fulfil the role of a builder 114, and one of the entities 116 and 118 to fulfil the role of an electrician 120 for the building contractor 100.

Entities 102, 104, 106, 110, 112, 116 and 118 bid to undertake their respective roles 108, 114 and 120 within the terms of a negotiation template and negotiation rules these bids are assessed and agreements entered into as described above. However, in the present example the work of the carpenter party 108 depends on work of the builder party 114. For instance, the carpenter may need to know when the builder 114 is contracted to open up a fireplace in order to be able to build the fireplace subsequently. However, neither the carpenter 108 nor builder 114 need have any knowledge of the agreement entered into (or partly negotiated), for instance, with electrician party 120. There may also be elements of the agreement or proposed agreements between the builder 100 and one of the carpenter 108 or builder 114 to which the other need not have access; for instance the consideration involved in the contract proposed.

Accordingly, in the informing step 46 of FIG. 3 the information provided to each of the entities can vary according to the need they have for the relevant information. FIG. 7 represents a schematic illustration of contract information disclosed to the entities 102, 104, 106, 110, 112, 116 and 118 being part of the negotiation. In FIG. 7, a document 122 represents, schematically, a partly-instantiated multi-party agreement between intended parties 100, 108, 114 and 120 embodying the latest proposals determined optimally by the negotiation host. A partly-instantiated agreement is one that has still to be agreed. It may be a first proposal, a subsequent proposal or a final version before acceptance by the parties.

In the agreement 122 a first part 124 is provided with information accessible to all parties. This might include, for instance, general recital information, boiler plate terms etc. A second part 126 of the agreement 122 is viewable only by the entities 102, 104, 106 seeking admission into the role of the carpenter 108. A third part 128 of the agreement 122 is accessible only to the entities 110, 112 seeking admission into the role of the builder 114. A fourth part 130 of the agreement 122 is viewable only by the entities 116, 118 seeking admission to the role of the electrician 120.

A fifth part 132 of agreement 122 is viewable by both the entities 102, 104, 106 seeking admission as the carpenter 108 and the entities 110, 112 seeking admission as the builder 114 because these relate to those aspects of the agreement in which the party playing the role of the carpenter 108 will need to interact with the party playing the role of the builder 114.

Thus visibility rules enforce that participants that have been admitted to play a certain role have a restricted view over other participants proposals. Each participant will only be able to see the part of the other proposals that are directly relevant to the role they want to fulfil.

Accordingly, this enables entities to propose modifications to relevant parts of the contract without having access to other non-relevant parts. Accordingly, when all parties have agreed, each will have proposed a partly-instantiated contract that is consistent with all the others and hence the negotiation host will be able to produce the final contract according to the agreement formation rules.

There are many ways in which visibility of parts of the agreement may be restricted, for instance only part of the agreement may be sent to the relevant entity, or encryption can be used.

It will be appreciated that embodiments of the present invention can be applied to many different negotiations and, therefore, the present invention is not restricted to the invention type specified herein.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A computer system for allowing negotiation of a multi-party agreement between a plurality of entities, the computer system comprising a plurality of computer nodes; a computer node being arranged to define negotiation rules between the entities; wherein the computer node is operable for a plurality of entities to bid for one or more of a plurality of roles in the negotiation, in which one entity can constrain the role or roles of another entity for an acceptable negotiation.

2. A computer system according to claim 1, in which the constraint is of the role or roles to be undertaken by another entity.

3. A computer system according to claim 2, in which the constraint is that another party shall fulfil a specified role or roles.

4. A computer system according to claim 2, in which the constraint is that another party shall not fulfil a specified role or roles.

5. A computer system according to claim 1, in which the constraint is a parameter of the negotiation.

6. A computer system according to claim 5, in which the parameter is a parameter value.

7. A computer system according to claim 1, wherein a plurality of nodes are arranged to define the negotiation between the entities with a set of negotiation activities; wherein each of the plurality of nodes are operable to implement a plurality of negotiation rule sets.

8. A computer system according to claim 1, wherein at least one of the entities is a software negotiation agent.

9. A computer system according to claim 8, wherein the computer node incorporates the software negotiation agent.

10. A computer system according to claim 7, wherein at least one of the entities is a user.

11. A computer system according to claim 1, wherein at least one of the entities is a negotiation host and at least another of the entities is a negotiation participant.

12. A computer system according to claim 1, wherein at least one of the rule sets constrains the negotiation activities to an auction and at least another rule set constrains the negotiation activities to a one on one negotiation.

13. A computer system according to claim 1, wherein the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

14. A computer system according to claim 13, wherein the negotiation activities further includes a protocol enforcer for rejecting invalid proposals.

15. A computer system according to claim 14, wherein the negotiation activities further includes an information editor for providing to the negotiation locale summarised proposal information.

16. A computer system according to claim 15 wherein the negotiation activities further includes an agreement maker for determining criteria for establishing an agreement based on the received proposals.

17. A computer system for allowing negotiation of a multi-party agreement between a plurality of entities each entity having a role or roles in the negotiation, the computer system comprising a plurality of computer nodes; a computer node being arranged to define negotiation rules between the entities; wherein an at least partly-instantiated agreement is provided to a plurality of entities and the at least partly-instantiated agreement is selectively revealed to the entities according to their role or roles.

18. A computer system according to claim 17, in which a part of the at least partly-instantiated agreement is revealed to all entities.

19. A computer system according to claim 17, in which a part of the at least partly-instantiated agreement is revealed to a plurality of entities but not to all entities, according to their role or roles.

20. A computer system according to claim 17, wherein a plurality of nodes are arranged to define the negotiation between the entities with a set of negotiation activities; wherein each of the plurality of nodes are operable to implement a plurality of negotiation rule sets.

21. A computer system according to claim 17, wherein at least one of the entities is a software negotiation agent.

22. A computer system according to claim 21, wherein the computer node incorporates the software negotiation agent.

23. A computer system according to claim 20, wherein at least one of the entities is a user.

24. A computer system according to claim 17, wherein at least one of the entities is a negotiation host and at least another of the entities is a negotiation participant.

25. A computer system according to claim 17, wherein at least one of the rule sets constrains the negotiation activities to an auction and at least another rule set constrains the negotiation activities to a one on one negotiation.

26. A computer system according to claim 17, wherein the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

27. A computer system according to claim 26, wherein the negotiation activities further includes a protocol enforcer for rejecting invalid proposals.

28. A computer system according to claim 27, wherein the negotiation activities further includes an information editor for providing to the negotiation locale summarised proposal information.

29. A computer system according to claim 28 wherein the negotiation activities further includes an agreement maker for determining criteria for establishing an agreement based on the received proposals.

30. A computer node for coupling to a computer system to allow negotiation of a multi-party agreement between a plurality of entities, the computer node comprising a processor, the processor being configured to define negotiation rules between the entities; wherein the computer node is operable for a plurality of entities to bid for one or more of a plurality of roles in the negotiation, in which one entity can constrain the role or roles of another entity for an acceptable negotiation.

31. A computer node according to claim 30, in which the constraint is of the role or roles to be undertaken by another entity.

32. A computer node according to claim 31, in which the constraint is that another party shall fulfil a specified role or roles.

33. A computer node according to claim 31, in which the constraint is that another party shall not fulfil a specified role or roles.

34. A computer node according to claim 30, in which the constraint is a parameter of the negotiation.

35. A computer node according to claim 34, in which the parameter is a parameter value.

36. A computer node according to claim 30, wherein at least one of the entities is a software negotiation agent.

37. A computer node according to claim 36, wherein the computer node incorporates the software negotiation agent.

38. A computer node according to claim 30, wherein at least one of the entities is a user.

39. A computer node according to claim 30, wherein at least one of the entities is a negotiation host and at least another of the entities is a negotiation participant.

40. A computer node according to claim 30, wherein at least one of the rule sets constrains the negotiation activities to an auction and at least another rule set constrains the negotiation activities to a one on one negotiation.

41. A computer node for allowing negotiation of a multi-party agreement between a plurality of entities each entity having a role or roles in the negotiation, the computer node comprising a processor; the computer node being arranged to define negotiation rules between the entities; wherein an at least partly-instantiated agreement is provided to a plurality of entities and the at least partly-instantiated agreement is selectively revealed to the entities according to their role or roles.

42. A computer node according to claim 41, in which a part of the at least partly-instantiated agreement is revealed to all entities.

43. A computer node according to claim 41, in which a part of the at least partly-instantiated agreement is revealed to a plurality of entities but not to all entities, according to their role or roles.

44. A computer node according to claim 41, wherein at least one of the entities is a software negotiation agent.

45. A computer node according to claim 44, wherein the computer node incorporates the software negotiation agent.

46. A computer node according to claim 41, wherein at least one of the entities is a user.

47. A computer node according to claim 41, wherein at least one of the entities is a negotiation host and at least another of the entities is a negotiation participant.

48. A computer node according to claim 41, wherein at least one of the rule sets constrains the negotiation activities to an auction and at least another rule set constrains the negotiation activities to a one on one negotiation.

49. A method for negotiation communication for a multi-party agreement between a plurality of entities via a distributed electronic network having a plurality of nodes, the method comprising in a node defining negotiation rules between the entities; and allowing entities to bid for one or more of a plurality of roles; the negotiation, in which one entity can constrain the role or roles of another entity for an acceptable negotiation.

50. A method for negotiation communication for a multi-party agreement between a plurality of entities via a distributed electronic network having a plurality of nodes, the method comprising in a node defining negotiation rules between the entities; providing to a plurality of entities an at least partly-instantiated agreement, and selectively revealing the partly-instantiated agreement to the entities according to their role or roles.
